(19) United States
(12) Patent Application Publication
(10) Pub. No.: US 2019/0300288 A1
(43) Pub. Date: Oct. 3, 2019

(54) ALIGNMENT AND DISPENSING APPARATUS FOR LINEAR PARTS

(71) Applicants: Philip K. Morin, BRISTOL, CT (US); Stanley G. Tomalesky, PLANTSVILLE, CT (US)

(72) Inventors: Philip K. Morin, BRISTOL, CT (US); Stanley G. Tomalesky, PLANTSVILLE, CT (US)

(21) Appl. No.: 16/364,456

(22) Filed: Mar. 26, 2019

Related U.S. Application Data
(60) Provisional application No. 62/649,880, filed on Mar. 29, 2018.

(51) Int. Cl. B65G 21/20; B29C 49/42; B65G 47/24

(52) U.S. Cl. CPC B65G 21/2054; G01N 35/0099; B65G 47/24; B29C 49/4205

(57) ABSTRACT

This invention relates to an alignment apparatus for linear shaped parts to allow downstream operations in a manufacturing process that receives linear piece-parts, of three-dimensional objects such as longitudinal cylinder, a right rectangular prism, rectangular cuboid, rectangular parallelepiped, triangle prism, pentagonal prism, octagonal prism, hexagonal prism, tetrahedrons, pyramidal shape, which then aligns and dispenses the piece-part in a preferred orientation. The apparatus causes the piece-part to travel in a specific direction for further processing, such as drilling, heat-treating, or attaching other parts.

### CROSS-REFERENCE TO RELATED APPLICATIONS

This non provisional patent application claims the priority benefit under 35 U.S.C. 120 of U.S. provisional patent application Ser. No. 62/649,880, filed on Mar. 29, 2018, the entire disclosure of which are hereby incorporated by reference.

### FIELD OF THE INVENTION

This invention relates to an alignment apparatus for linear shaped parts to allow downstream operations in a manufacturing process.

### BACKGROUND OF THE INVENTION

An alignment apparatus is a mechanism that receives linear piece-parts, as by way of example, an up stage stamping, molding, draw press, or extrusion, of a three-dimensional object, such as a rectangular bar or a cylinder, which then quickly aligns and dispenses the object in a preferred alignment to travel in a specific direction for further processing, such as drilling, heat treating, or attaching other parts. Without an auto mechanism for aligning the parts, some processes could not be automated and a manufacturer would have to resort to a manual alignment, which would require the use of one or both hands.

### SUMMARY OF THE INVENTION

This invention generally relates to an alignment and dispensing apparatus for piece-parts having a longitudinal dimension greater than a lateral dimension, as for example, a longitudinal cylinder, or other three-dimensional objects, for example, but not limited to, a triangle prism, pentagonal prism, octagonal prism and hexagonal prisms, tetrahedrons, pyramidal shape, a right rectangular prism, rectangular cuboid, or rectangular parallelepiped. The apparatus for determining the orientation of piece-parts that are being transported in a either in a longitudinal or vertical direction, having a length-wise size portion and other portions of different sizes measured in a direction transverse to said length-wise direction, includes a conveyance such as a transporting conveyor, if moving in a horizontal direction, or uses gravity feed, to move parts vertically along a predetermined path, toward an orientation sensor, which allows detection of shape or dimension, and thereafter may engage a flexible wheel or an extended arm that contacts the part to physically orient it in a preferred alignment. Thereafter, an air valve plunger or an electrical solenoid supplies a mechanical assist to eject the part from the mechanism.

In one embodiment of the invention the alignment and dispensing mechanism processes a bullet casing, by way of example and not limitation, using an in-feed conveyor to move horizontally the piece-part into the field of view of a camera, whereby the camera is programmed to detect the piece-part shape as the piece-part moves in line with respect to other piece parts, to contact a wheel that deposits the piece-part onto a rotator, which turns the piece-part substantially ninety degrees, to coincide with other parallel facing piece-parts aligned on an outfeed belt.

In one embodiment of the invention the alignment and dispensing mechanism incudes a vertically oriented feed tube sized to contain in-line piece-parts, and which allows the piece-parts to move one-by-one into an adjoining escapement chamber, a holding mechanism traps the piece-part, while one or more sensors determine the piece-part orientation; an eject channel, receives the piece-part after determination of piece-part orientation; a tipping arm pushes the piece-part into a preferred alignment; after which a pushing mechanism ejects the piece-part from an eject channel such that the piece-part ejects in the preferred alignment.

In another embodiment of the invention the alignment and dispensing mechanism processes a longitudinal cylinder, so that ultimately all the processed face points in one direction, such as with the narrow end or neck end facing of a bullet casing, in a preferred direction. The parts enter the mechanism via a feed tube sized to contain the piece-parts end-to-end without overlap allowing the parts to fall freely into an escapement chamber. An escape mechanism employs solenoids with plungers or equivalent mechanisms, such as air cylinders that trap the piece-part. Sensors detect the piece-part to establish whether the neck is in the upward or downward facing direction to establish the orientation of the piece-part. Upper escapement cylinders hold back the barrel of the piece-part before releasing it into an eject channel, such that it falls perpendicularly into the channel. A tipping motor rotates a tipping arm clockwise or counter clockwise to push the piece-part, which is sitting vertically in the eject channel, to fall in a left-ward or right-ward direction into the eject channel, such that by way of example and not limitation, the neck end exits the mechanism first.

A piece-part alignment method comprising the steps of: 1) conveying piece-parts in line via a feed tube into an adjoining escapement chamber; 2) trapping the piece-part, while determining the piece-parts orientation using a sensing mechanism; 4) releasing the piece-part, such that it falls perpendicularly into an eject channel; 5) based on the sensing mechanism and a preferred alignment, rotating a tipping arm, clockwise or counter clockwise dependent on the preferred alignment; 6) pushing the piece-part into an ejection channel, such that the piece-part is in a preferred alignment with other adjacent piece-parts.

### BRIEF DESCRIPTION OF THE DRAWINGS

FIG. 1 is a perspective view of a positioning and dispensing mechanism in accordance with an embodiment of the invention.

FIG. 2 is perspective view of a positioning and dispensing mechanism in accordance with a preferred embodiment of the invention.

### DETAILED DESCRIPTION OF THE INVENTION

The following detailed description includes the best mode of carrying out the invention and is made for the purpose of illustrating the general principles of the invention and should not be taken in a limiting sense. The scope of the invention is determined by reference to any claims. Each part or function is assigned, even if structurally identical to another part, a unique reference number wherever that part is shown in the drawing figures.

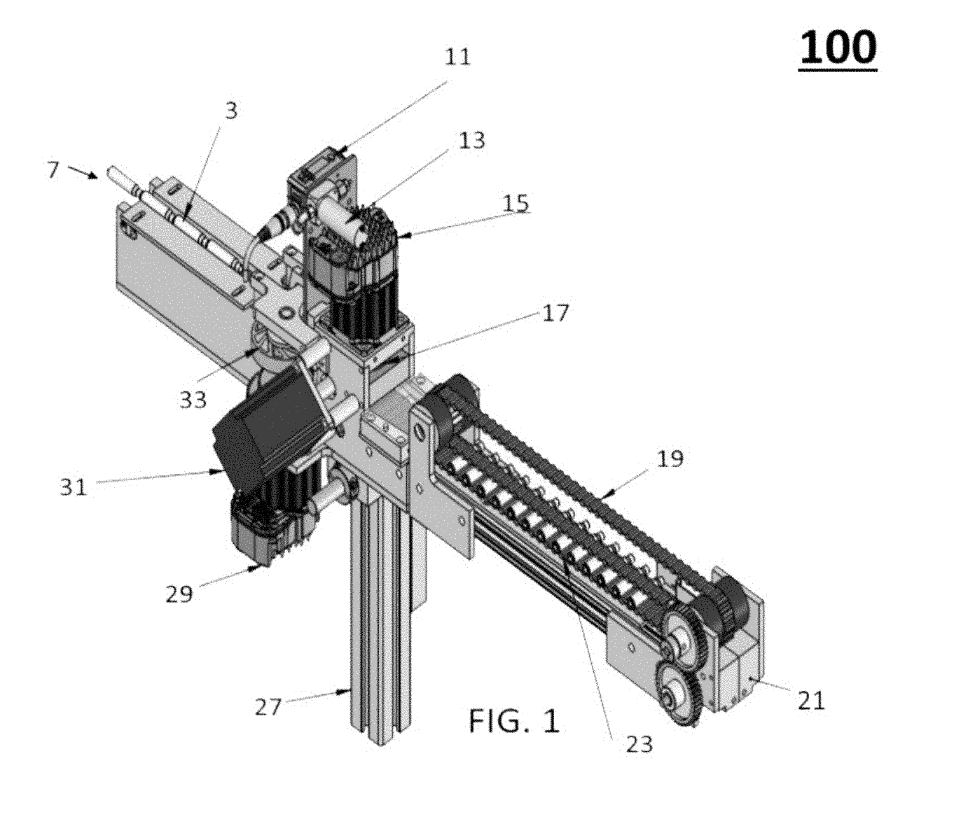

Referring to FIG. 1, the invention disclosed herein relates to the piece-part alignment and dispensing mechanism 100 for processing three-dimensional parts, by way of example and not limitation, a cylindrical object comprised of a barrel and a neck cylindrical piece-part 7, manufactured as by way of example, an up stage stamping, molding, draw press, or extrusion of a three-dimensional object. The FIG. 1 perspective view shows the relative positioning of functional elements combined and mounted on a mounting strut 27, which operates for the piece-part 7 alignment and dispensing in accordance with one embodiment of the invention.

An in-feed conveyor 3 accepts a stream of piece-part 7, as in the case of a ballistics bullet, comprising a barrel section and a neck from a source, such as a rotating conveyor container, known to those of reasonable skill in the mechanical arts. A stream of piece-part 7 travel beneath the aperture of a camera 11. The camera 11 is a mini single purpose vision sensor, programmed to detect virtually any shape within its field of view. In this application, the camera is programmed to detect one end of the piece-part 7, in order to establish whether the neck of the piece-part as it moves in a serial, sequential direction with respect to other piece parts, is in a facing upstream of the part movement or facing downstream of the direction of movement, for the purpose of aligning the piece-part 7 with other piece-parts in parallel facing the same direction.

A flexible wheel 33 contacts the piece-part from a fixed axle location and deposits the piece-part onto a rotator 17, which accepts the piece-part 7, and turns the piece-part via a rotator motor 15, substantially ninety degrees (or any desired angle), to coincide with the orientation of an outfeed belt 23, which is grooved.

A solenoid air valve optionally supplies, on command, an air jet to assist piece-part motion. The outfeed belt and an optional part hold-down belt 19 retain the piece-part from the point at which the rotator 17 deposits the piece-part onto the grooved out belt 23. The piece-part hold-down belt 19 and the outfeed belt 23 are driven by a belt drive motor 31 and a customary drive interface. These mechanisms and interfaces are well known by those of ordinary skill in the art of mechanical engineering. A discharge guide 21 assists in discharging the piece-part 7 to a location where the next stage of a process begins.

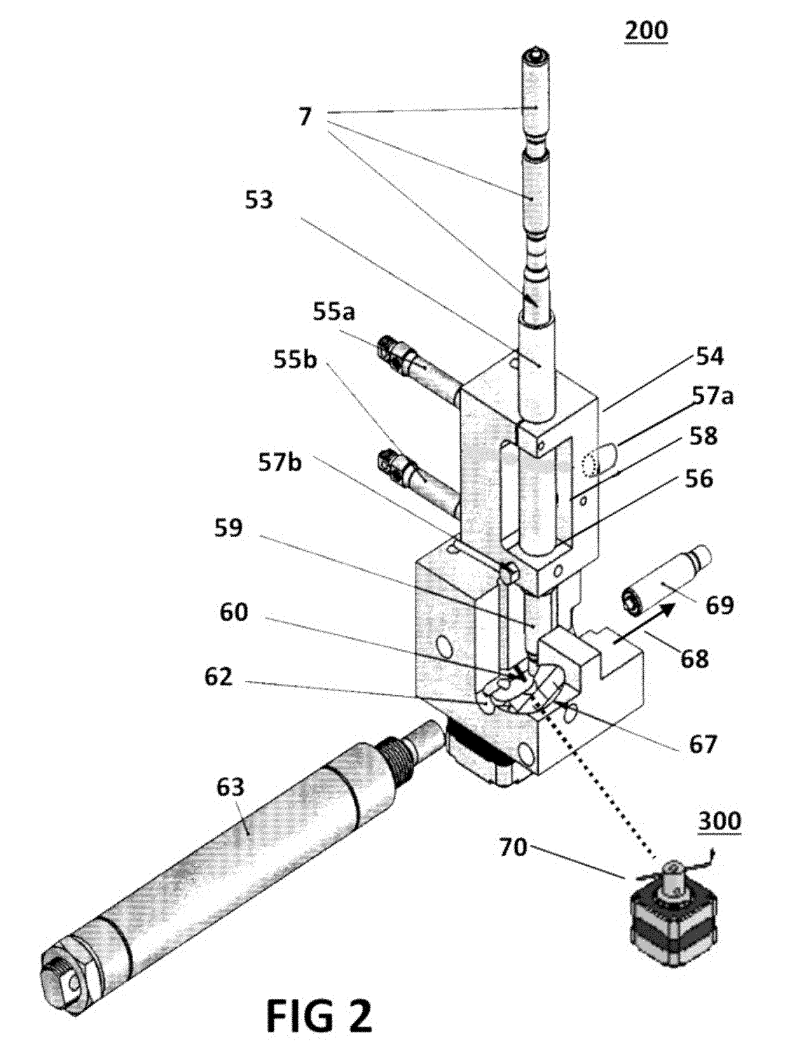

As was the case in FIG. 1 mechanism 100, when assembling, processing or packaging parts with a significant aspect ratio, part orientation is often essential, where a specific end of the piece-part must be oriented with the correct end in one direction. A preferred embodiment of the invention is described in FIG. 2, where mechanism 200 provides for orienting the piece-part 7.

Referring to FIG. 2, the invention disclosed herein relates to the piece-part alignment and dispensing mechanism 200 for processing by way of example and not limitation, a cylindrical casing, having a barrel and a neck, referred to as a piece-part 7, manufactured as by way of example, an up stage stamping, molding, draw press, or extrusion of a three-dimensional object. The FIG. 2 perspective view shows parts to be oriented piece-part 7, where some parts are oriented having the cylinder case neck of the part facing in a downward direction and others having the neck facing in an upward direction.

The parts enter the mechanism 200 via a feed tube 53, sized to contain in line piece-parts 7 that is end-to-end without overlap (referred to as shingling), while allowing the piece-parts to fall freely into an adjoining escapement chamber 58. A holding mechanism 54 employs solenoids with plungers or equivalent mechanisms, such as two air cylinders, referred to as upper escapement cylinder 55a and lower escapement cylinder 55b that that trap the lower end 56 of piece-part 7.

Sensors 57a and 57b detect the piece-part 7 in its field of view in order to establish whether the neck is in the upward or downward facing direction to establish the orientation of the piece-part 7. The sensors may be photoelectric sensors, mechanical arm sensors, or a camera as in FIG. 1, 11, which image can be sensed to determine the presence and orientation of the piece-part 7. In the preferred embodiment in FIG. 2, two such sensors 57a and 57b detect the presence and the orientation of the piece-part 7.

The upper escapement cylinder 55a and the lower cylinder 55b releases the piece-part 7 into the eject channel 59, such that it falls perpendicularly into the eject channel 62. Generally, the end of the eject channel is extended sufficiently to prevent the piece-part 7 from falling into the eject channel 62 horizontally. The width of the eject channel 62 is made to control the tipping of and the direction of the falling piece-part 7.

More specifically, based on piece-part 7 orientation as detected by sensors 57a and 57b, the tipping motor 30 rotates a tipping arm 70 clockwise or counter clockwise to push the piece-part 7, which is sitting vertically in the eject channel 62, to fall in a left-ward or right-ward direction into the eject channel 62, oriented such that the neck end faces the direction of arrow 68, exiting the mechanism 200. It is clear that the alignment may be changed through a directional change to the tipping arm 70 so that the barrel end of piece-part 7 exits, in a preferred alignment.

Once the piece-part 7 has been aligned by the tipping arm 70 a pushing mechanism, such as an ejector air cylinder pushes the piece-part 7 out of the eject channel 62. The device is controlled by a programmable logic controller (PLC) not shown. The PLC controls the general movement of the piece-part 7 through the process. When the escapement cylinders release piece-part 7, another waiting piece-part 7 falls freely into escapement chamber 58.

Signal inputs to the PLC are detected from the sensors 57a, 57b, when piece-part 7 is in the escapement chamber 58: (1) to control the timing of the actuation of a pushing mechanism, such as air eject cylinders 55a, 55b, which release the piece-part 7 into the eject channel 62; (2) to control the timing of the actuation of tipping motor 30 tipping arm 70; (3) to control the timing of the actuation of the pushing mechanism, ejector air cylinder 63. A permanent bar magnet or a programmable electromagnet may be placed below the eject channel 62 to speed up part tipping and settling in of the part 7 into the eject channel 62.

In accordance with the mechanism 100 disclosed in FIG. 1, the invention disclosed herein also includes a method for piece-part 7 alignment including: 1) conveying via a feed conveyor 3 a stream of piece-parts 7 from a rotating conveyor barrel; 2) imaging the piece-parts 7 beneath the aperture of a vision sensor; 3) detecting the shape of the piece-part 7 from input received from the vision sensor 11; 4) detecting one end of the piece-part 8, in order to establish the orientation of the piece-part 7; 5) contacting a flexible wheel 33 and the piece-part 7 from a fixed axle location; 6) depositing the piece-part 7 onto a rotator 17, said rotator 17, accepting the piece-part 7; 7) turning the piece-part 7, substantially plus or minus ninety degrees (or any desired programmable angle), to coincide with the orientation of an outfeed belt 23; 8) retaining the piece-part between the outfeed belt 23 and a part hold-down belt 19; 9) discharging the piece-part 7 in a location where the next stage of a manufacturing process continues.

In accordance with the mechanism 200 disclosed in FIG. 2, the invention disclosed herein also includes a method for piece-part 7 alignment. The method includes: 1) conveying piece-parts 7 via a feed tube 53; 2) allowing the parts to fall freely; 3) trapping the lowest piece-part 7; 4) detecting the whether the neck end of the part 7 is downward; 5) releasing the piece-part 7 into the eject channel, such that it falls perpendicularly into the eject channel; 6) detecting part orientation by one or more sensors 57a, 57b; 7) rotating a tipping arm 70 clockwise or counter clockwise to push the piece-part 7 sitting vertically in the eject channel 62; 8) causing the piece-part 7 to fall in a left-ward or right-ward alignment into the eject channel aligned such that the neck end faces the direction of exiting the mechanism 200; 9) ejecting the part 7 out of the eject channel.

While the foregoing invention has been described, additional modifications and changes can be made without departing from the spirit of the invention. Accordingly, such modifications and changes are considered to be within the scope of the appended claims.

We claim:

1. A piece-part alignment mechanism comprising: an in-feed conveyor to move a piece-part into the field of view of a camera, the camera programmed to detect the piece-part shape as the piece-part moves in line with respect to other piece-parts to contact a wheel that deposits the piece-part onto a rotator, which turns the piece-part substantially ninety degrees, to coincide with parallel facing piece-parts aligned on an outfeed belt.

2. A piece-part alignment mechanism comprising: a feed tube sized to contain in line piece-parts, and which allows the piece parts to move singularly into an adjoining escapement chamber, a holding mechanism to trap the piece-parts, while one or more sensors determine the piece-part orientation; an eject channel, to receive the piece-part after determination of piece-part orientation; a tipping arm to push the piece-part into a preferred alignment; a pushing mechanism to eject the piece-part from the eject channel such that piece part ejects in the preferred alignment.

3. A piece-part alignment method comprising the steps of: 1) conveying a piece-part in line via a feed tube into an adjoining escapement chamber; 2) trapping the piece-part, while determining the orientation of the piece-part, utilizing a sensing mechanism; 4) releasing the piece-part, such that it falls perpendicularly into an eject channel; 5) based on the sensing mechanism and a preferred alignment, rotating a tipping arm, one of clockwise or counter clockwise, dependent on the preferred alignment; 6) pushing the piece-part into an ejection channel, such that the piece-part is in the preferred alignment with other adjacent piece-parts.

4. The piece-part alignment mechanism in claim 1, wherein the rotator accepting the piece-part turns the piece-part, substantially plus or minus ninety degrees or any desired programmable angle.

5. The piece-part alignment mechanism in claim 2, where the holding mechanisms to trap the piece-parts are one or air cylinders or electrical actuated solenoids with plungers.

6. The piece-part alignment mechanism in claim 2, wherein the one or more sensors to determine the piece-part orientation are one or more photo sensors or cameras.

7. The piece-part alignment mechanism in claim 2, wherein a tipping arm to push the piece-part into a preferred alignment is attached to a tipping motor.

8. The piece-part alignment mechanism in claim 2, wherein the pushing mechanism to eject the piece-part from the eject channel is one of an air cylinder or electrical actuated solenoids with plunger.

9. The piece-part alignment mechanism in claim 2, wherein the movement of the piece-part timing is controlled by a programmable logic controller.

10. The piece-part alignment mechanism in claim 6, wherein the tipping motor rotates the tipping arm clockwise or counter clockwise.

11. The piece-part alignment mechanism in claim 9, wherein the programmable logic controller based on the sensor determines the piece-part orientation.

12. The piece-part alignment mechanism in claim 9, wherein the programmable logic controller based on the sensor determines when to release the piece-part from the escapement chamber.

13. The piece-part alignment mechanism in claim 2, wherein the piece-part is one of a: (1) longitudinal cylinder, (2) three-dimensional object, (3) a right rectangular prism, (4) rectangular cuboid, (5) rectangular parallelepiped, (6) triangle prism, (7) pentagonal prism, (8) octagonal prism, (9) hexagonal prism, (10) tetrahedrons, (11) pyramidal shape.
